(19) United States
(12) Patent Application Publication
(10) Pub. No.: US 2017/0030276 A1
(43) Pub. Date: Feb. 2, 2017

(54) METHOD FOR ASCERTAINING THE CHARGING OF A STORE FOR HYDROCARBONS

(71) Applicant: Robert Bosch GmbH, Stuttgart (DE)

(72) Inventors: Jochen Knecht, Reutlingen (DE); Guido Schock, Loewenstein (DE); Thomas Herges, Eberdingen (DE)

(21) Appl. No.: 15/222,433

(22) Filed: Jul. 28, 2016

(30) Foreign Application Priority Data
Jul. 29, 2015 (DE) 102015214322.8

(51) Int. Cl. F02D 41/00; F02M 25/08

(52) U.S. Cl. CPC F02D 41/0045; F02M 25/0836; F02M 25/0854

(57) ABSTRACT

A method for ascertaining the charging of a store for hydrocarbons originating from a fuel tank of a vehicle is characterized in that the charging of the store is determined from a variable characterizing the fuel outgassing with the aid of a model which maps the vapor pressure curve of the fuel.

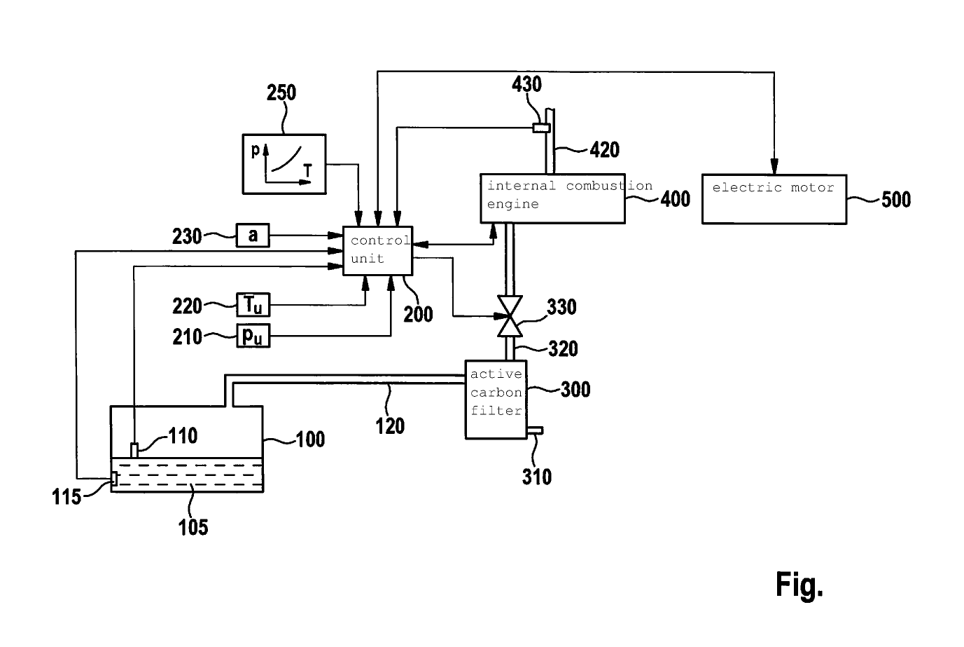

### CROSS REFERENCE

The present application claims the benefit under 35 U.S.C. §119 of German Patent Application No. DE 102015214322.8 filed on Jul. 29, 2015, which is expressly incorporated herein by reference in its entirety.

### FIELD

The present invention relates to a method for ascertaining the charging of a store for hydrocarbons originating from a fuel tank of a vehicle. Moreover, the present invention relates to a computer program which is configured for carrying out each step of the method according to the present invention, and a machine-readable memory medium on which the computer program according to the present invention is stored. Lastly, the present invention relates to an electronic control unit which is configured for ascertaining the charging of a store for hydrocarbons originating from a fuel tank of a vehicle with the aid of the method according to the present invention.

### BACKGROUND INFORMATION

In contemporary vehicles with gasoline engines, the charging of a store for hydrocarbons originating from a fuel tank of the vehicle, usually achieved by an active carbon filter, is ascertained via a lambda deviation when a tank vent valve is opened. For hybrid vehicles, in operating states with purely electric operation it is not possible to determine the charging of the active carbon filter. Instead, the internal combustion engine must be started for a charge determination, which has disadvantages with regard to the operating strategy of these types of hybrid vehicles.

A method for ascertaining the charging of an active carbon filter for gaseous hydrocarbons originating from a fuel tank of a vehicle is described in German Patent Application No. DE 10 2011 015 998 A1, in which a pressure is detected in the fuel tank. Based on the pressure, at least one variable is ascertained, preferably a volume flow through a vent line, or a frequency of opening of a shutoff valve, on the basis of which the charging of the active carbon filter with gaseous hydrocarbons is ascertained. With knowledge of the charging of the active carbon filter, a tank vent valve may then be controlled in such a way that rapid and efficient purging of the active carbon filter is made possible during regeneration of same. This method is used for a pressure tank system. However, the method is not readily transferable to vehicles without pressure tank systems.

A method and a device for determining the charging of a fuel vapor temporary store in internal combustion engines is described in German Patent Application No. DE 10 2006 027 527 A1, in which the weight of the fuel vapor temporary store is determined, and the charging is deduced by a comparison with the previously determined weight of the empty fuel vapor temporary store. Although this allows the charging of the fuel vapor temporary store to be determined without having to start the internal combustion engine, determining the weight of the fuel vapor temporary store is associated with additional measures which cannot be readily implemented in vehicles, and which also result in additional technical effort as well as additional costs.

### SUMMARY

The method according to the present invention for ascertaining the charging of a store for hydrocarbons originating from a fuel tank of a vehicle, in which the charging of the store is determined from a variable characterizing the fuel outgassing with the aid of a model which maps the vapor pressure curve of the fuel, has the advantage that it may also be used in particular in vehicles without pressure tank systems, and that no additional hardware outlay is necessary; i.e., additional sensors, additional sensor lines, additional control devices, or the like do not have to be provided.

Instead, the charging is determined from the variable characterizing the fuel outgassing, which is ascertained from a model which maps the vapor pressure curve of the fuel.

According to the present invention, the vapor pressure is understood to mean the pressure that results when the vapor is in thermodynamic equilibrium with the associated liquid phase in a closed system. The vapor pressure is a function of the temperature, and rises with increasing temperature. The vapor pressure is also a function of the pressure, and depends on the ambient pressure, for example. In addition, the vapor pressure is a function of the fuel used, in particular the composition of the fuel used. Thus, purely in principle, the fuel used and its composition may be deduced from the vapor pressure curve. One advantage of the method according to the present invention is that the internal combustion engine does not have to be started in order to determine the fuel outgassing, and thus, to determine the charging of the active carbon filter. The method according to the present invention is therefore also usable in hybrid vehicles and in particular in plug-in hybrid vehicles, which may also travel for fairly long distances in purely electric mode.

In one advantageous embodiment of the method, it is provided that a variable characterizing the fuel temperature and/or a variable characterizing the change in the fuel temperature over time are/is determined, and are/is taken into account in ascertaining the variable characterizing the fuel outgassing. The temperature may be detected with a temperature sensor, for example, which in most cases is installed in the vehicle anyway. However, the temperature may also be ascertained from a temperature model as a function of the ambient conditions of the fuel temperature. Since the ambient temperature is taken into account for control purposes in present internal combustion engines, no additional sensors or the like are necessary for this purpose. The change in the fuel temperature over time is also understood to mean in particular the change in the fuel temperature due to fairly long shutdown periods. To take fairly long shutdown periods into account, for example the average ambient temperature is ascertained, and daytime or nighttime phases may be taken into account with the aid of a model.

In addition, it is advantageously provided that the ambient pressure is ascertained and used for correcting the model which maps the vapor pressure curve of the fuel. Namely, the vapor pressure curve is also a function of the ambient pressure, as already mentioned above.

To be able to take dynamic influences into account, one advantageous embodiment of the method provides for detecting the acceleration of the fuel tank, and using it for correcting the model which maps the vapor pressure curve of the fuel. The acceleration may be ascertained by sensors or may be computed with the aid of a model. Since the outgassing processes are influenced by motion of the liquid in the tank, this specific embodiment allows the vapor pressure curve, and thus the fuel outgassing, to be determined more precisely.

These dynamic influences, referred to as dynamic correction for short, are advantageously taken into account with the aid of at least one correction factor for the vapor pressure curve.

According to another very advantageous specific embodiment, it is provided that the filling level of the fuel tank and/or changes in the filling level are/is ascertained, and the variable characterizing the fuel outgassing is ascertained as a function of the filling level/the changes in the filling level. It is thus possible in particular to recognize whether a refueling has taken place. The detection of the filling level allows the fuel quantity that is refueled during a refueling to be ascertained (computed), and thus allows the ratio of refueled fuel to residual fuel to be determined, which is relevant for the determination of the fuel outgassing.

The computer program according to the present invention is configured for carrying out each step of the method according to the present invention, in particular when it runs on a computer or a control unit. The computer program allows the implementation of the method according to the present invention in a conventional electronic control unit without having to make structural changes to same. For this purpose, the computer program is stored on the machine-readable memory medium according to the present invention.

The electronic control unit according to the present invention is obtained by running the computer program according to the present invention on a conventional electronic control unit. The electronic control unit is configured for ascertaining the charging of a store for hydrocarbons originating from a fuel tank of a vehicle with the aid of the method according to the present invention.

### BRIEF DESCRIPTION OF THE DRAWINGS

Exemplary embodiments of the present invention are illustrated in the FIGURES, and are explained in greater detail below.

The FIGURE schematically illustrates a tank vent system of a vehicle, in which the method according to the present invention is used.

### DETAILED DESCRIPTION OF EXAMPLE EMBODIMENTS

A tank vent system of a vehicle includes a fuel tank 100 in which a fuel 105 is present. Fuel 105 has a filling level height which is detected by a filling level sensor 110. The signal of filling level sensor 110 which represents the filling level height is transmitted to a control unit 200. A sensor 115 for detecting the fuel temperature is also situated in the tank. The signal of temperature sensor 115 is likewise relayed to control unit 200 and processed in same. A line 120 leads from tank 100 to an active carbon filter 300. Active carbon filter 300 includes a vent line 310. A tank regeneration line 320 leads from active carbon filter 300 to an internal combustion engine 400. A shut-off valve 330 which is controllable by control unit 200 is situated in line 320. Valve 330 is commonly referred to as a tank vent valve. When a critical charging of active carbon filter 300 occurs, tank vent valve 330 is opened. In this case, the hydrocarbons which have accumulated on the active carbon in active carbon filter 300 are suctioned out, in a manner of speaking, by the negative pressure prevailing in intake line 410 and are supplied to the intake tract of internal combustion engine 400, where they are combusted. The resulting mixture, which is richer compared to the usual operation, is detected by a lambda sensor 430 situated in exhaust duct 420, and the signals of the lambda sensor are likewise supplied to control unit 200.

In addition, the following sensors are provided, whose output signals are supplied to control unit 200: a pressure sensor 210 which detects ambient pressure p_{U}, a temperature sensor 220 which detects ambient temperature T_{U}, and an acceleration sensor 230 which detects acceleration a. This acceleration sensor 230 may also be dispensed with, and the acceleration may be computed with the aid of a model. The function of these sensors is discussed in greater detail below.

In addition, the FIGURE shows a block 250 in which a vapor pressure curve p(T) is schematically illustrated. This block 250 is also discussed in greater detail below.

In addition to internal combustion engine 400, the vehicle also includes an electric motor 500 via which the vehicle is solely drivable. Internal combustion engine 400 as well as electric motor 500 are controllable by control unit 200. In a driving state in which the vehicle is driven solely by electric motor 500, it is not possible to determine the charging of active carbon filter 300. Internal combustion engine 400 must be started for a charging determination. However, this results in disadvantages with regard to the operating strategy, which, for example, provides electric operation with electric motor 500. To avoid starting internal combustion engine 400, according to the present invention a charging model is now provided which maps the vapor pressure curve of the fuel in tank 100. This charging model is schematically illustrated by block 250. The outgassing of the fuel is determined from the vapor pressure curve of the fuel. This takes place with knowledge of the temperature curve of the fuel, the ambient pressure and the associated ambient pressure correction of the vapor pressure curve, and the filling level and the change in the filling level, in particular with knowledge of the quantity of existing fuel in tank 100 and the quantity of refueled fuel in tank 100, and lastly, with knowledge of the dynamic influences, i.e., whether the vehicle is accelerated or decelerated, which causes sloshing of the fuel 105 in the tank, which changes the outgassing process.

The temperature curve of fuel 105 may be determined on the one hand by temperature sensor 115, but on the other hand may also be ascertained as a function of the ambient conditions, in particular ambient temperature T_{U} which is detected by sensor 220. The fuel temperature is ascertained by a temperature model as a function of these ambient conditions. In this regard, sensor 115 in the tank may also be dispensed with. If fuel temperature sensor 115 is installed, in addition to the described temperature model, a maximum selection of the temperature takes place, provided that the signal is assumed to be valid.

In order to take extended shutdown periods of the vehicle into account, in addition the average ambient temperature is ascertained, and daytime or nighttime phases are taken into account via a model. For shutdown phases in which the fuel has cooled down, “discharging” of active carbon filter 300 takes place due to the cooling. If cooling occurs during a shutdown phase, the computation of the discharge takes place in the subsequent driving cycle.

In addition, an ambient pressure correction of the vapor pressure curve takes place. For this purpose, ambient pressure p_{U} is ascertained by pressure sensor 210.

A dynamic correction takes place in order to also take the mentioned dynamic influences into account. For this purpose, acceleration a is ascertained by acceleration sensor 230. Alternatively or additionally, a computation of the acceleration may take place in a model. These dynamic influences are taken into account in a charging model, implemented in block 250, which determines the outgassing of the fuel from the vapor pressure curve. The influences are taken into account in each case by correction factors.

During refueling, the filling level detection computes the ratios of refueled fuel to residual fuel in tank 100 and stores same until another refueling is recognized. The charging model in block 250 in each case computes a separate charging of active carbon filter 300 for the residual fuel and the refueled fuel. This is used to preferably accurately ascertain the age of fuel 105 present in tank 100, and to take this into account. In the charging model in block 250, for both portions, i.e., the existing fuel present in the tank and the refueled fuel, the outgassing mass as a function of the filling level is integrated over the pressure curve and temperature curve with the aid of the vapor pressure curve. The age of the fuel may be taken into account by numerical mapping of this curve and storing the already outgassed mass.

The charging of active carbon filter 300 is determined by the outgassing mass and by the mass that is regenerated when the engine is running. When a charging limit of active carbon filter 300 is reached, the charging model implemented in block 250 prompts a start of internal combustion engine 400 for regenerating active carbon filter 300. The residual charging of active carbon filter 300 via the purging strategy may be set at a predefinable and applicable value so that efficient purging takes place as a function of the ambient conditions. When a start of internal combustion engine 400 is prompted, the actual charging is adjusted for the setpoint charging which is computed by the charging model in block 250. This results in a correction factor with which the vapor pressure curve, which forms the starting basis for the charging model implemented in block 250, is corrected. This is used to adapt various fuel grades. It is provided that the model is to be reset to the originally stored curve when a refueling is recognized. Thus, if a refueling is recognized, the most recently stored value for the fuel aging for the residual fuel is adopted in the model.

The model is then reinitialized with new parameters for the refueled fuel quantity. The outgassing of the refueled fuel and of the residual fuel is determined on this basis.

The method may be implemented as a computer program in control unit 200. By storing on a machine-readable memory medium, it is possible to retrofit existing control units 200, since additional sensors are not necessary.

What is claimed is:

1. A method for ascertaining the charging of a store for hydrocarbons originating from a fuel tank of a vehicle, comprising:
determining the charging of the store from a variable characterizing fuel outgassing with the aid of a model which maps a vapor pressure curve of the fuel.

2. The method as recited in claim 1, wherein at least one of: a variable characterizing a fuel temperature, and a variable characterizing a change in the fuel temperature over time, is determined, and is taken into account in ascertaining the variable characterizing the fuel outgassing.

3. The method as recited in claim 2, wherein at least one of: the variable characterizing the fuel temperature, and the variable characterizing the change in the fuel temperature over time, is determined from at least one of a measured ambient temperature and a temperature model.

4. The method as recited in claim 1, wherein an ambient pressure is ascertained and used for correcting the model which maps the vapor pressure curve of the fuel.

5. The method as recited in claim 1, wherein an acceleration of the fuel tank is ascertained and used for correcting the model which maps the vapor pressure curve of the fuel.

6. The method as recited in claim 1, wherein at least one of: a filling level of the fuel tank, and changes in the filling level of the fuel take, is ascertained, and the variable characterizing the fuel outgassing is ascertained as a function of the at least one of the filling level and the changes in the filling level.

7. A machine-readable memory medium on which is stored a computer program for ascertaining the charging of a store for hydrocarbons originating from a fuel tank of a vehicle, the computer program, when executed by a processor, causing the processor to perform:
determining the charging of the store from a variable characterizing fuel outgassing with the aid of a model which maps a vapor pressure curve of the fuel.

9. An electronic control unit which is configured for ascertaining a charging of a store for hydrocarbons originating from a fuel tank a of a vehicle, the control unit designed to:
determine the charging of the store from a variable characterizing fuel outgassing with the aid of a model which maps a vapor pressure curve of the fuel.
